(19) United States
(12) Patent Application Publication
(10) Pub. No.: US 2015/0309178 A1
(43) Pub. Date: Oct. 29, 2015

(54) Handling Assistance Data For Global Positioning

(71) Applicant: Nokia Technologies Oy, Espoo (FI)

(72) Inventors: Jari Tapani Syrjarinne, Tampere (FI); Mikko Blomqvist, Lempäälä (FI)

(73) Assignee: Nokia Technologies Oy, Espoo (FI)

(21) Appl. No.: 14/650,717

(22) PCT Filed: Jan. 10, 2013
(86) PCT No.: PCT/IB2013/050234

§ 371 Date: Jun. 9, 2015

(51) Int. Cl. G01S 19/06; H04W 4/02

(52) U.S. Cl. CPC G01S 19/06; H04W 4/02

(57) ABSTRACT

A receiving apparatus (30) for determining a geographical position is disclosed which comprises an application-level program providing a local data server (38) to which other components within the apparatus (30) can connect and communicate using a local port, the local data server (38) being configured to connect to an external source of position assistance data (32), to receive said data in a first predetermined format and to convert it into a second predetermined format for provision within the apparatus (30) using said local port. The apparatus (30) also comprises a satellite positioning receiver (36) and a receiver protocol module (34) associated with said receiver (36) and configured, in response to a request to provide position assistance data to said receiver (36), to connect to the local data server (38) using said local port, to request said position assistance data from the local data server (38), to receive it in the second predetermined format and to convert it into a third predetermined format suitable for the satellite positioning receiver (36).

### FIELD OF THE INVENTION

This invention relates to handling assistance data for global positioning

### BACKGROUND TO THE INVENTION

Assistance data is crucial for a satellite positioning receiver, such as a Global Positioning System (GPS) or Global Navigation Satellite System (GNSS) receiver, to provide location fixes rapidly after starting up.

Assistance data typically consists of a set of information elements (IEs) carrying reference location, reference time and satellite clock and orbit data. Satellite clock and orbit data together are typically called ephemeris data. Ephemeris data, together with other aiding means available in a mobile phone (such as reference frequency from the cellular modem) will boost and accelerate the performance of an integrated GPS receiver so that a time to first fix (TTFF) can usually be provided in 5-10 seconds with a 5 metre accuracy. In comparison, a GPS receiver without any assistance cannot provide the first fix in less than 30-40 seconds even in optimal signal reception conditions.

Assistance data and its delivery mechanism nowadays form part of published cellular standards offering industry-wide accepted formats and methods for GPS and GNSS data elements and consequently for performance improvements. Such published standards include 3GPP TS 440.031, 3GPP TS 25.331, OMA SUPL 1.0 and, in the near future, the industry will be using OMA SUPL 2.0, 3GPP TS 36.355 and OMA LPPe v1.0.

In addition, there also exist a large number of proprietary assistance data services and protocols which are typically provided by and/or limited to use with the hardware of certain manufacturers or with certain location based services. An example is Nokia's A-GNSS protocol. These services and protocols do not necessarily follow the formats and protocols in the published standards but can offer significant performance improvements in terms of TTFF and receiver sensitivity. Due to such proprietary services currently being closely linked to the low-level functionality of receivers, a change to a proprietary service (or the development of a new one) will generally require driver-level changes and/or additions to firmware. In the worst cases, the architecture of the receiver may prevent integration of a new service or seriously degrade performance if a new service is used. This will lead to considerable delays in time-to-market if changes or new functionality is or are required in the firmware or architecture of the receiver.

### SUMMARY OF THE INVENTION

A first aspect of the invention provides apparatus, comprising:
a local data server configured to connect to an external source of position assistance data, to receive said data in a first predetermined format and to convert it into a second predetermined format for provision within the apparatus;
a satellite positioning receiver; and
   a receiver protocol module associated with said receiver and configured, in response to a request to provide position assistance data to said receiver, to request said position assistance data from the local data server, to receive it in the second predetermined format and to convert it into a third predetermined format suitable for the satellite positioning receiver.

Assistance data in this sense can comprise one or more of, but is not limited to, reference location, reference time and satellite clock and orbit data. As will be explained later on, the local data server may receive one or some IE(s) from the external source(s) and generate locally other assistance data. For example, the local data server can fetch orbit model data from the external source and produce the reference location locally for provision of the combined assistance data to the receiver protocol module.

The local data server may be configured to connect to a plurality of different external sources of position assistance data and to receive respective different sets of position assistance data for conversion into the second predetermined format.

The local data server may be configured to connect to the or each external source of position assistance data using a packet switching connection. The connection may be a TCP/IP connection.

The local data server may be configured to connect to the or each external source of position assistance data to obtain the position assistance data in response to a request received from the receiver protocol module.

The local data server may be configured to connect to the or each external source of position assistance data over a cellular communications network.

The local data server may be configured automatically and periodically to connect to the or each external source of position assistance data to obtain the position assistance data for storage and provision to the receiver protocol module at a later point in time.

Where different sets of position assistance data are received, the local data server may be configured to combine data from the different sets to provide a new set of position assistance data for conversion into the second predetermined format.

The local data server may be provided as an application-level program. The local data server may be configured so as to be installed, reconfigurable and/or replacable from an external location over a communications network.

The local data server may give an associated local port address to which the receiver protocol module is configured to connect to in order to request position assistance data. The local port address may be a local IP address.

The local data server may be configured to receive the position assistance data in the form of one or more information elements in a non-binary encoded format and to convert the element (s) into a binary encoded format. The non-binary encoded format may be a mark-up language format, e.g. the extensible mark-up language (XML). The binary encoded format may be an ASN format, e.g. ASN.1.

The local data server may be configured to receive position assistance data in the form of one or more information elements conforming to a first schema and to convert the element (s) into a second schema. Examples of schema include, but are not limited to, scale factor, word length, and data type. For example, one schema might define “int32” where the other is “int16”, and/or one schema might define “double” whereas the other is “float”.

The local data server may be configured to request and receive position assistance data from the or each external source of position assistance data using a first predefined communications protocol. The first predefined communications protocol may be a non-standardized communications protocol for the exchange of position assistance data.

The receiver protocol module may be configured to request and receive position assistance data from the local data server using a second predefined communications protocol which is different from the first communications protocol. The second predefined communications protocol may be a standardized communications protocol for the exchange of position assistance data. For example, the second predefined communications protocol may conform to one of the published 3GPP standards, such as 3GPP TS 440.031, 3GPP TS 25.331 or 3GPP TS 36.355, or to one of the published OMA standards, such as OMA SUPL 1.0 or OMA LPPe v.1.0.

The receiver protocol module may be configured to convert the position assistance data into low-level signals for transfer to the satellite positioning receiver over a physical interface, e.g. a UART, I2C or SPI interface.

The local data server may be configured communicate with the or each external source of position assistance data using a first security method or protocol and with the receiver protocol module internally using a second, different, security method or protocol.

The local data server may be further configured to generate locally a set of position assistance data, not present in the data received from the external source, for provision of the combined sets within the apparatus.

A second aspect of the invention provides apparatus comprising:
an application-level program providing a local data server to which other components within the apparatus can connect and communicate using a local port, the local data server being configured to connect to an external source of position assistance data, to receive said data in a first predetermined format and to convert it into a second predetermined format for provision within the apparatus using said local port;
a satellite positioning receiver; and
a receiver protocol module associated with said receiver and configured, in response to a request to provide position assistance data to said receiver, to connect to the local data server using said local port, to request said position assistance data from the local data server, to receive it in the second predetermined format and to convert it into a third predetermined format suitable for the satellite positioning receiver.

A third aspect of the invention provides a method comprising, in a data processing apparatus:
(i) connecting to an external source of position assistance data, receiving said data in a first predetermined format, and converting it into a second predetermined format; and
(ii) responsive to a request for position assistance data, requesting and receiving position assistance data from the local data server in the second predetermined format, converting the position assistance data into a third predetermined format suitable for a satellite positioning receiver, and providing the converted position assistance data to a satellite positioning receiver.
   (i) may further comprise connecting to a plurality of different external sources of position assistance data and receiving respective different sets of position assistance data for conversion into the second predetermined format.
   (i) may be performed using a TCP/IP connection.
   (i) may be performed over a cellular communications network.
   (i) may be performed automatically and periodically to obtain the position assistance data for use in (ii) at a later point in time.
   (i) may further comprise combining data from the different sets of position assistance data to provide a new set of position assistance data for conversion into the second predetermined format.
   (i) may be performed by an application-level program which provides a local data server.

The method may further comprise delivering, installing, reconfiguring and/or replacing the local data server from an external location over a communications network.

(ii) may comprise requesting and receiving position the assistance data via a predetermined local port address, e.g. a local IP address.
(i) may comprise receiving the position assistance data in the form of one or more information elements in a non-binary encoded format and converting the element(s) into a binary encoded format.

The non-binary encoded format may be a mark-up language format, e.g. XML.

The binary encoded format may be an ASN format, e.g. ASN.1.

(i) may comprise receiving the position assistance data in the form of one or more information elements conforming to a first schema and converting the element(s) into a second schema.
(i) may comprise requesting and receiving position assistance data from the or each external source of position assistance data using a first predefined communications protocol.

The first predefined communications protocol may be a non-standardized communications protocol for the exchange of position assistance data.

(ii) may comprise requesting and receiving position assistance data from the local data server using a second predefined communications protocol which is different from the first communications protocol.

The second predefined communications protocol may be a standardized communications protocol for the exchange of position assistance data.

The second predefined communications protocol may conform to one of the published 3GPP standards, such as 3GPP TS 44.031, 3GPP TS 25.331 or 3GPP TS 36.355.

The second predefined communications protocol conforms to one of the published OMA standards, such as OMA SUPL 1.0 or OMA LPPe v.1.0.

(ii) may comprise converting the position assistance data into low-level signals for transfer to the satellite positioning receiver over a physical interface, e.g. a UART, I2C or SPI interface.

The receiving or provision of data in step (i) may be performed using a first security method or protocol and in step (ii) using a second, different, security method or protocol.

Step (i) may further comprise generating locally at the local data server a set of position assistance data, not present in the data received from the external source, and step (ii) may further comprise receiving the combined sets from the local data server.

A fourth aspect of the invention provides a computer program comprising instructions that when executed by a computer apparatus control it to perform the method defined above.

A fifth aspect of the invention provides a non-transitory computer-readable storage medium having stored thereon computer-readable code, which, when executed by a computing apparatus, causes the computing apparatus to perform a method comprising:
(i) connecting to an external source of position assistance data, receiving said data in a first predetermined format, and converting it into a second predetermined format; and
(ii) responsive to a request for position assistance data, requesting and receiving position assistance data from the local data server in the second predetermined format, converting the position assistance data into a third predetermined format suitable for a satellite positioning receiver, and providing the converted position assistance data to a satellite positioning receiver.

A sixth aspect of the invention provides an apparatus, the apparatus having a least one processor and at least one memory having computer-readable code stored thereon which when executed controls the at least one processor:

to connecting to an external source of position assistance data, to receive said data in a first predetermined format, and to convert it into a second predetermined format; and responsive to a request for position assistance data, to request and receive position assistance data from the local data server in the second predetermined format, to convert the position assistance data into a third predetermined format suitable for a satellite positioning receiver, and to provide the converted position assistance data to a satellite positioning receiver.

### BRIEF DESCRIPTION OF THE DRAWINGS

The invention will now be described, by way of non-limiting example, with reference to the accompanying drawings in which:

FIG. 1 is a satellite positioning system;

FIG. 2 is a block diagram showing in overview a prior art system for providing assistance data to a receiver;

FIG. 3 is a block diagram showing in overview a first embodiment system for providing assistance data to a receiver;

FIG. 4 is a block diagram showing a second embodiment system for providing assistance data to a receiver;

FIG. 5 is a schematic diagram indicating certain functional modules in the receiver shown in FIG. 4;

FIG. 6 is a schematic diagram indicating functional sub-modules of a local server within the receiver shown in FIGS. 4 and 5; and

FIG. 7 is a flowchart illustrating processes occurring within the receiver of FIGS. 4 to 6.

### DETAILED DESCRIPTION OF EMBODIMENTS

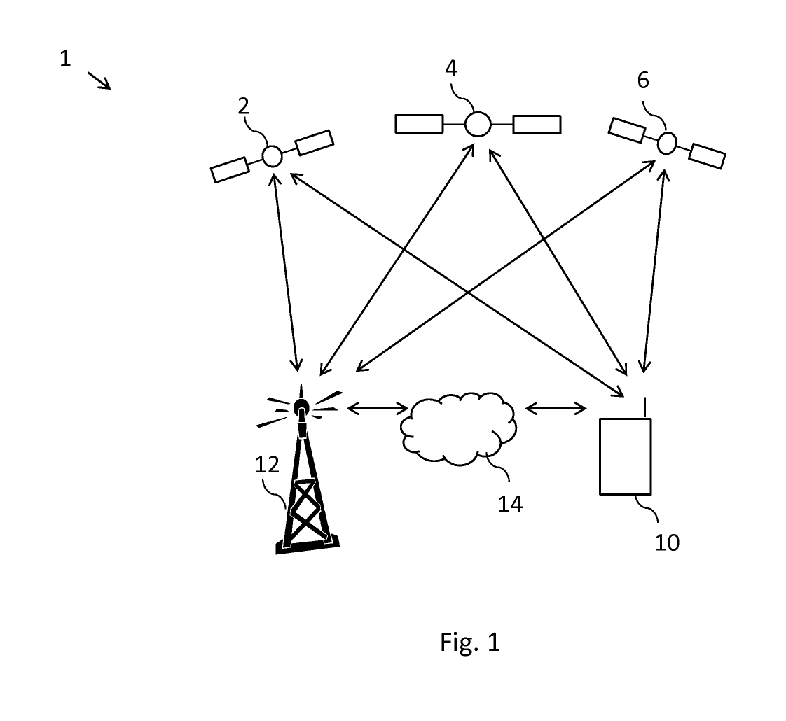

FIG. 1 shows in overview a satellite positioning system 1 which is useful for understanding embodiments of the invention. The system 1 comprises a constellation of satellites 2, 4, 6 orbiting the Earth, one or more receivers 10 and a source of assistance data in the form of server 12.

The system 1 may be a global or regional radio navigation satellite system such as Global Positioning System (GPS), GLONASS, GALILEO, COMPASS, SBAS (Satellite Based Augmentation System), QZSS (Quasi-Zenith Satellite System, Japan), IRNSS (Indian Regional Navigation Satellite System, India) or other satellite system. Each of these systems has a separate constellation of satellites, wherein each satellite has a managed orbit. Adjustments for maintenance or orbit corrections are often performed on an individual satellite basis but are performed by the constellation owner or management as needed.

As discussed in the preamble, in order to achieve a quick TTFF at a receiver 10, assistance data is generated at server (s) 12 using information received from the satellites 2, 4, 6. The assistance data is transmitted over a data network 14 to a receiver 10 when requested by the receiver. The assistance data is typically in the form of information elements (IEs) carrying reference location, reference time and ephemeris data, i.e. satellite clock and orbit data. For ease of explanation, assistance data IEs will be referred to simply as IEs hereafter.

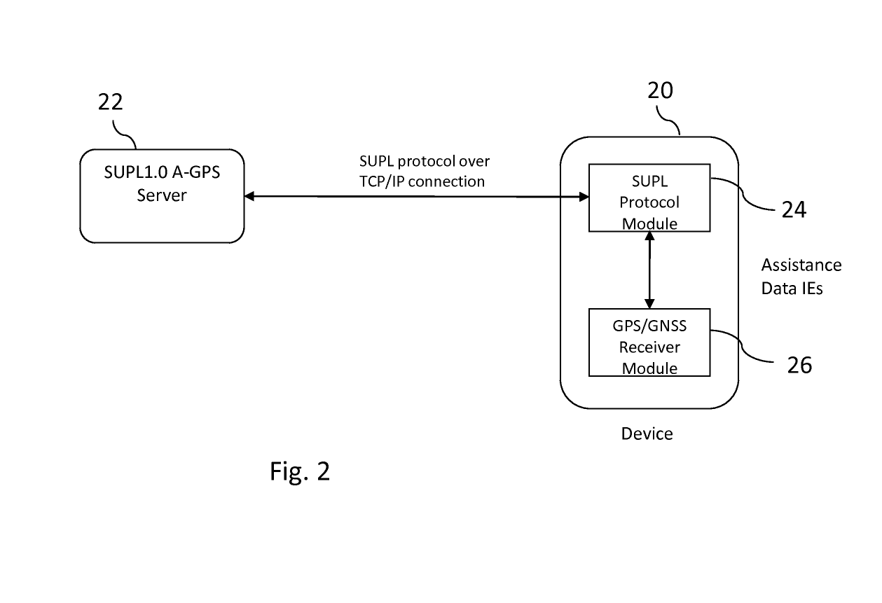

FIG. 2 is a schematic diagram showing a prior art system for exchanging IEs using a standardised protocol. A receiver 20 is configured, e.g. when a navigation application running thereon is switched on, to request and receives IEs from a server 22 over a cellular communications network such as a GPRS, 3G or 4G network using TCP/IP. The format of the IEs and the protocol by which they are exchanged will conform to a published standard, which in this case is SUPL1.0 A-GPS (SUPL 1.0).

At the receiver 20, there is provided a SUPL protocol module 24 and a GPS/GNSS receiver module 26. The receiver module 26 comprises a GPS receiver antenna, chipset and firmware. The SUPL protocol module 24 is usually embedded in the operating system (OS) of the receiver and provides an Application Programming Interface (API) by which it can transfer the data as low-level signals with the receiver module using a physical interface such as UART, I2C or SPI. The SUPL protocol module 24 is configured to convert IEs received from the server 22 using the SUPL standard to low-level signals required for injection to the receiver module 26. In practise, both modules 24, 26 are usually provided by the same vendor.

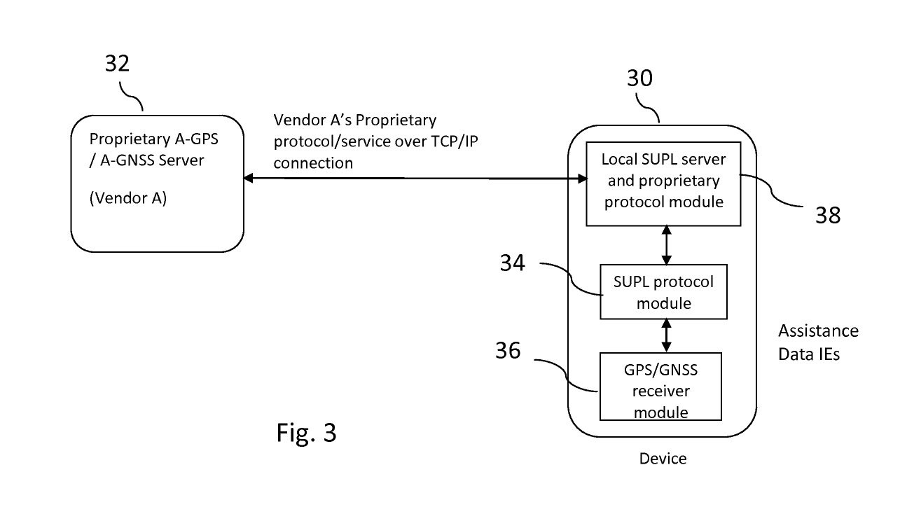

FIG. 3 is a schematic diagram showing a system for receiving assistance data IEs according to a first embodiment of the invention. Similar to FIG. 2, there is a receiver 30 and a server 32 for generating and transmitting IEs to the receiver. In this case, however, the server 32 is associated with a vendor A which generates and provides a proprietary assistance data service, including the dissemination of IEs using a proprietary format and/or communications protocol, aspects of which are different from the standardised one, SUPL 1.0. An example proprietary format is Nokia's A-GNSS protocol. Others include Qualcomm Inc.'s gpsOneXTRA and Rx Network Inc.'s PGPS services.

A SUPL protocol module 34 and a GPS/GNSS receiver module 36 are provided within the receiver 30; these can be the same as those described with reference to FIG. 2 and are therefore suitable for requesting and receiving IEs using the standardised protocol. Additionally, however, in the FIG. 3 embodiment there is provided a local SUPL server and proprietary protocol module 38 (hereafter simply “local server”) which is preferably an application-level program that can be uploaded, installed and updated without any change to the hardware, firmware or SUPL protocol module 34 in the OS (other than a minor change of port address). The local server 38 is configured to request using a proprietary protocol IEs from Vendor A's server 32, to receive the IEs in a proprietary format and to convert the IEs into a different format appropriate e.g. to the SUPL 1.0 standard.

The SUPL protocol module 34 is configured, by way of a simple software modification, to communicate with the local sever 38 via a local IP port or URL address, rather than communicating with an external source of assistance data, as is the case in FIG. 2. The SUPL protocol module 34 receives the IEs in the SUPL 1.0 format using the SUPL 1.0 protocol in the normal way for transfer to the receiver module 36.

Advantageously, the SUPL protocol and receiver modules 34, 36 which tend to be closely associated with each other in terms of their firmware and/or API setup do not need to be modified to cater for new proprietary protocols and/or data formats. By providing a local server 38 which sits between the SUPL protocol module 34 and the external source of IEs 32, new protocols and formats can be easily implemented without the need for architectural changes, firmware changes and/or large amounts of testing involved in implementing such changes. All that is needed is a change to the port setting of the SUPL protocol module 34 in the OS so that it connects to the local server 38 rather than an external one.

In other embodiments, the receiver 30 is configured to request IEs from multiple different external sources (servers) of assistance data. These may include multiple vendors of proprietary navigation services and/or a combination or different proprietary and standardised services. The receiver 30 can be configured using the local server 38 to combine data received from the different sources to create IEs conforming to a standardised, e.g. the SUPL 1.0, protocol and/or format.

Although SUPL 1.0 has been given as the example standardised format and protocol used between the local server 38 and the standardised protocol module 34, it will be appreciated that others including those listed in the preamble can be provided for in the local server 38 dependent on the standard used by the subsequent protocol and receiver stages 34, 36.

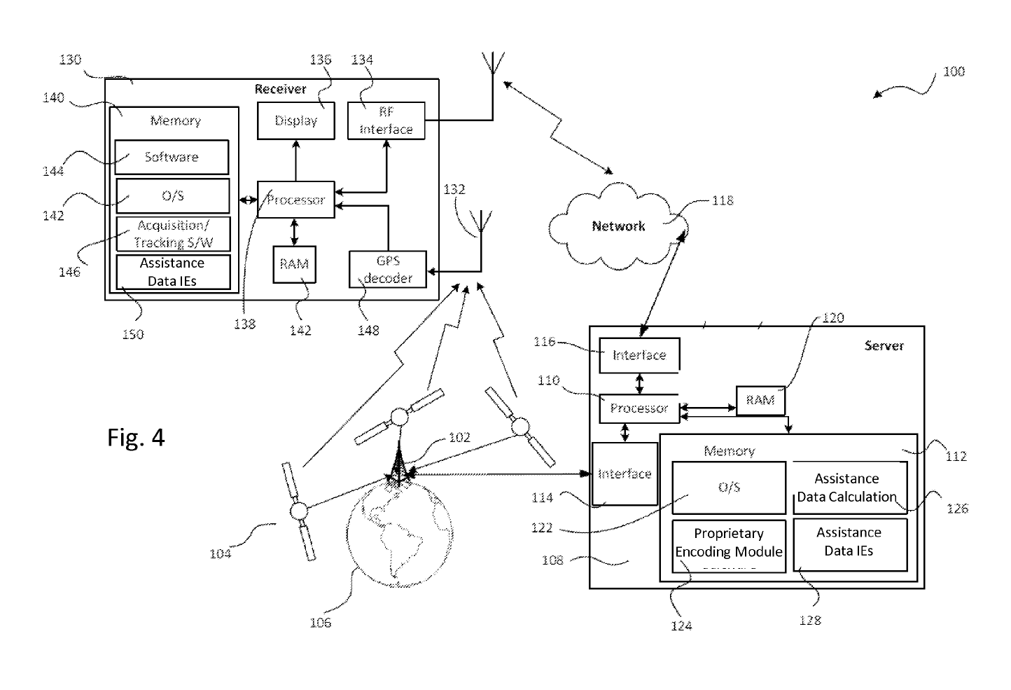

A more detailed, second, embodiment will now be described with reference to FIG. 4, which is a block diagram of a system 100. The system 100 includes the capability of collecting, creating, distributing and using assistance data.

The system 100 includes a satellite system 104. As mentioned above with reference to FIG. 1, the satellite system 104 can be any type of satellite system.

The satellite system 104 provides navigation data (ephemeris data, almanac data, ionosphere model, UTC model) or other satellite positioning data via a satellite link. This navigation data can be combined with ephemeris extension data files created separately of the satellite system 104 and used to enhance the performance of a wireless receiving device 130, which can also be termed a receiver. In some embodiments, the ephemeris extension data files can also be used as such for positioning purposes, totally replacing the broadcast ephemeris e.g. if the receiver is not able to receive navigation data from the satellites due to poor signal conditions.

The following disclosure uses GPS as the illustrative system, although those skilled in the art will understand how to practise the invention in conjunction with other satellite positioning systems and their constellations.

A network 102 of GPS tracking stations is used to collect data from the orbiting GPS satellites 104 including all the necessary IEs relevant for performance enhancement in the receivers, such as ephemeris data IEs. The network 102 may comprise several geographically separated tracking stations, each of which collects satellite data and measurements from plural satellites in the constellation.

A server 108 is connected to the network 102. The server 108 collects and processes the data and measurements provided by the network 102 using a proprietary data format and/or method.

Satellite measurements can include code phase measurements, carrier phase measurements and Doppler measurements for each supported signal and frequency. Satellite data can include ephemeris data (both clock and orbit), almanac data, ionospheric model, UTC model, satellite health information, regional models for ionosphere and/or troposphere, raw navigation data broadcast and data related to the integrity for the satellite signals, payload or services. In some embodiments, the satellite measurements and data are obtained from both the L1 and L2 frequencies and from all the relevant signals (e.g. L1CA, L1C, L2C) on which the GPS satellites 104 transmit. Alternative embodiments may use only one of these frequencies, and/or other frequencies used by other satellite systems or by future versions of the GPS system.

The server 108 comprises a number of components including a processor 110 and a memory 112. The processor 110 is bi-directionally connected to the memory 112. The memory 112 may be a non-volatile memory such as read only memory (ROM) a hard disk drive (HDD) or a solid state drive (SSD). The memory 112 stores, amongst other things, an operating system 122, a proprietary encoding module 124, assistance data calculation software 126, and an assistance data IE database 128 in which data sets, e.g. ephemeris data sets are stored. The server 108 includes an interface 116 for communication with a network 118. The interface 116 may be an RF interface, another wireless interface, or a wired interface. The network 118 may be a packet network such as the internet, a local area network, or a telephony network. Volatile memory in the form of Random Access Memory (RAM) 120 is connected to the processor no. The RAM 120 is used by the processor 110 for the temporary storage of data when executing the software stored in the memory 112. The operating system 122 contains code which, when executed by the processor 110 in conjunction with the RAM 120, controls operation of each of the hardware components of the server 108.

The assistance data calculation module 126 is configured to collect and calculate the assistance data, where necessary, for example by using physical data to generate ephemeris extension files for 7 or 14 days or even longer. The proprietary encoding module 124 is configured to encode the IEs into the proprietary format, which will specify a particular schema for the assistance data and the file format, e.g. a mark-up format such as XML. This module 124 also specifies the proprietary protocol by which the proprietary IEs are transferred using the interface 114. This may include a specification of data rate, for example.

The IEs in the proprietary format are stored in the IE database 128 for dissemination over the interface 114 and are updated and/or replaced as and when dictated by controlling software in the memory 112.

The system 100 also includes a receiver 130. The receiver 130 may be a mobile phone, a handheld navigation system, digital camera, or an embedded navigation system such as a car safety system. The GPS signal is decoded with the GPS decoder/receiver 148. The receiver 130 is able to receive live telemetry, ephemeris data and almanac data from the satellite system 104 through its GPS antenna 132 and GPS decoder/receiver 148. The receiver 130 is also able to send server requests via its RF interface or a communication port provided to the receiver e.g. in the embedded systems 134 over a network 118 and to receive assistance data IEs, such as ephemeris extension files, stored in the IE database 128 of server 108.

The receiver 130 includes a display 136, a processor 138, and memory 140. The processor 138 is connected to volatile memory in the form of RAM 142. The processor 138 is bi-directionally connected to the memory 140. The memory 140 has stored within, amongst other things, an operating system 142, software 144, satellite acquisition/tracking software 146 (e.g. a GPS navigation system) and assistance data IEs 150 received from the server 108. The operating system 142 contains code which, when executed by the processor 138 in conjunction with the RAM 142, controls operation of each of the hardware components of the receiver 130.

The GPS decoder/receiver 148 comprises the hardware chipset and associated firmware/software for receiving GPS signals from the satellites 104 and calculating position, which may include the use of assistance data IEs.

A SUPL 1.0 protocol module which is associated with the GPS decoder/receiver 148 is integrated into the OS 142 and communicates with the decoder/receiver over a physical interface using low-level signals.

The software 144 includes an application-level program which is a local SUPL server and proprietary protocol module (hereafter simply “local SUPL server”).

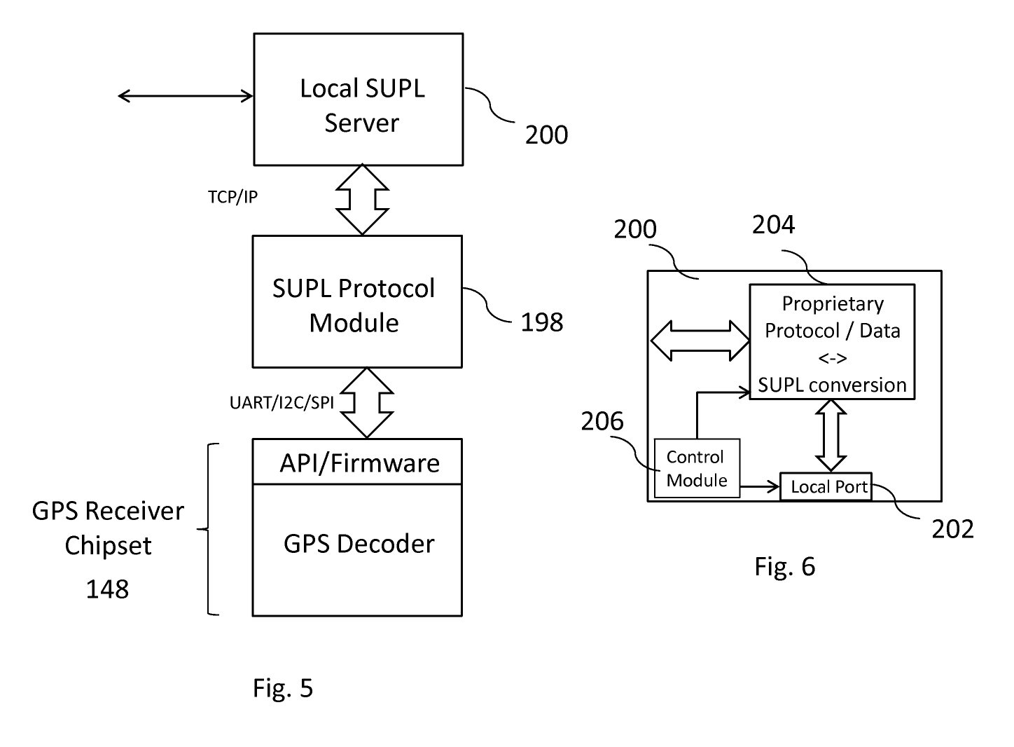

FIG. 5 is a block diagram showing the logical arrangement of the various modules in the receiver 130 involved in requesting and receiving IEs from the external server 108. The GPS decoder/receiver 148 includes the hardware and firmware for exchanging IEs over a physical port, e.g. using UART, I2C or SPI based on requests made to a server using the SUPL 1.0 protocol 198. This ‘server’ is in this case not an external server but the local SUPL server 200 stored on memory 140 and which has a local port address, e.g. 127.0.0.1 (local host). The SUPL protocol module 198 which is embedded in the OS 142 is configured to connect to this local port address and thereafter requests are made, and data received, over a TCP/IP link using the SUPL 1.0 protocol and data format.

Referring to FIG. 6, the local SUPL server 200 comprises the above-mentioned local port 202, a proprietary to SUPL conversion module 204 and a control module 206. The control module 206 comprises software for controlling the logical order of data transfers and the address(es) of external servers, e.g. that of server 108 and/or other proprietary servers, from which IEs are requested and received. The proprietary to SUPL conversion module 204 converts or maps data received from server 108 to the SUPL 1.0 format and transfers it to the SUPL protocol module 198 using the SUPL 1.0 protocol. Similarly, requests for IEs made from the SUPL protocol module 198 in the SUPL 1.0 standard are interpreted and converted into proprietary format.

To give one example, the server 108 may generate assistance data IEs, including extended ephemeris IEs, using Nokia's A-GNSS protocol. This generates an XML file following a particular schema (e.g. with defined scale factor, word length and data type) which is different from the strict definition used by SUPL 1.0.

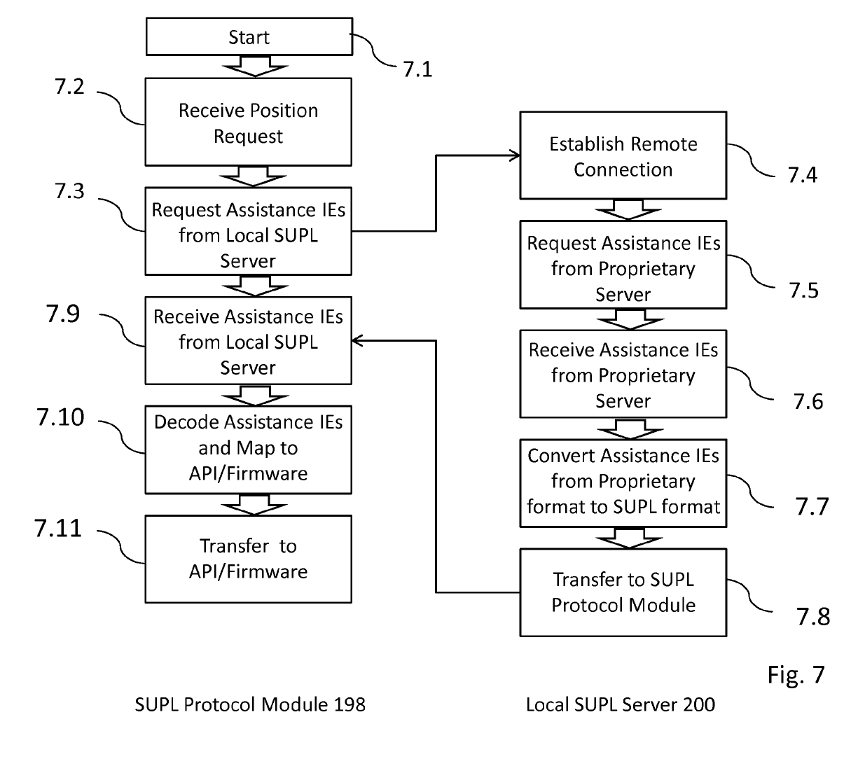

Referring to FIG. 7, which shows the typical order of processing steps between the SUPL protocol module 198 and the local SUPL server 200, the process starts at steps 7.1 and 7.2 when a position request is received or initiated at the SUPL protocol module 198. In step 7.3, the SUPL protocol module 198 connects and passes a request to the local SUPL server 200 for IEs using SUPL 1.0.

In step 7.4, the local SUPL server 200 (if it does not already have the required IEs stored locally) establishes a remote TCP/IP connection to the address of the Nokia A-GNSS server 108. In step 7.5, the local SUPL server 200 requests IEs from the Nokia server 108 using its proprietary protocol, and receives the IEs which conform to Nokia's schema in step 70.6. In step 7.7, the local SUPL server 200 converts the IEs into the SUPL 1.0 format and in step 70.8, the converted IEs are transferred to the SUPL protocol module 198 using SUPL 1.0.

In step 7.9 the SUPL protocol module 198 receives the IEs in the SUPL 1.0 format. In step 70.10, the IEs are decoded and mapped to the GPS receiver's APIs and firmware as low-level signals. In step 70.11, the signals are transferred to the GPS receiver via its APIs and so the position can be determined.

A typical format conversion of IEs in the above example is as follows:

At the external server 108, the IEs are encoded in XML. When received at the local SUPL server 200, the XML is decoded and enclosed into a binary format, e.g. ASN.1, which is the format used by SUPL 1.0. At the SUPL protocol module 198, the binary ASN.1 is decoded and converted and/or mapped to the APIs and firmware of the particular receiver's chipset. The resulting signals are transferred over the physical UART/I2C/SPI interface.

Of note is the difference in file size between the formats; the XML IEs received at the local SUPL server 200 will usually be large compared to the binary converted version which is provided to the SUPL protocol module 198, even though the content remains the same. The binary version is extremely compact compared with the non-binary version which means that compact, standardized IEs are stored in the SUPL server 200 for use by the SUPL protocol module 198 when required.

The reverse process of signal and data conversion can also take place.

As well as mere format changes, other schema changes can be applied. These may relate to word length, scale factors, lifetime of the assistance data etc.

The steps described in FIG. 7 relate to the situation where the SUPL protocol module 198 initiates a request for IEs. However, steps 7.4 to 7.7 can be performed independently of the SUPL protocol module 198 from time to time, e.g. automatically and periodically, to obtain updated IEs for immediate use by the receiver 108 when a fix is needed. Such IEs may be ephemeris extension files which can last for up to 7 or 14 days before a new, automatic update is required.

Further, as previously indicated, it is possible that the IEs required from a particular request from the SUPL protocol module 198 are already present in the local SUPL server 200 requiring no external connection at that time.

Although SUPL 1.0 has been given as the example standardised format and protocol used between the local (SUPL) server 200 and the (SUPL) protocol module 34, it will be appreciated that others including those listed in the preamble can be provided for, including, but not limited to 3GPP TS 440.031, 3GPP TS 25.331, OMA SUPL 1.0, OMA SUPL 2.0, 3GPP TS 36.355 and OMA LPPe v1.0.

In the above embodiments, the assistance data IEs exchanged between the external server and the receiver 32,108 and the local server 38, 200 of the receiver 30, 130 can include any or all of the following:

Navigation Model. This IE contains the satellite orbit and clock model parameters for the positioning and signal acquisition processes. The data is also called ephemeris data. Extensions to this data can also be provided, e.g. 7 or 14 day or even longer extensions.

Reference Time. This IE contains the reference GPS (or GNSS) time for positioning and signal acquisition processes, which could optimally be linked to the cellular system time for the best possible time accuracy. In the latter case, the reference time can be used directly for sensitivity improvement, possibly improving the signal acquisition by 3-6 dB.

Reference Location. This IE contains the estimated location of the receiver, which can be used as an initial location in positioning and/or also in the signal acquisition process improving the sensitivity in weak signal conditions. The reference location could be determined e.g. from the identity of the serving cellular cell tower (Cell-ID) or from the identity of the near-by WLAN access points (usually the MAC address).

In some embodiments, the local server may receive just one or a subset of these IEs from the external server and locally generate one or more other IEs for sending using the standardised protocol. For example, the local data server can fetch orbit model data from the external source and produce locally the reference location for provision of the combined data internally.

The local server 38, 200 in the above embodiments can support any or all of the following conversions from proprietary IE formats and protocols to standardised IEs. This list is exemplary and non-exhaustive.

Ephemeris data for GPS, GLONASS or Galileo. The 7/14 day (or even longer) extended ephemeris IEs can be mapped to standardised navigation model IEs, e.g. in 3GPP TS 44.031 v.8.0 and onwards.

Reference location. Proprietary Cell-ID and WiFi positioning services can be mapped into standardised reference location IEs. It is also possible to use the location data produced locally in the receiver device if the device has a local database of cell tower or WiFi access point locations.

Reference time. Proprietary time services, e.g. NTP services, can be converted into standardized reference time IEs. This makes it possible to offer very precise time assistance to the GPS/GNSS receiver module. It is also possible to use the resources residing in the receiver device to maintain accurate time and to use this as a source of time assistance.

Differential corrections. Proprietary services and data for ionosphere models can be converted into standardized Differential GPS (DGPS) or DGNSS corrections. This makes it possible improve the positioning accuracy regionally even down to sub-meter level. Also, the ionosphere models and services from SBAS can be converted into SUPL format in the local server.

Ephemeris extensions. Proprietary ephemeris extension services can be mapped into standardized ephemeris data information elements. This makes it possible to reduce the connectivity to the servers and make the receivers work autonomously e.g. in roaming cases.

Although the above assumes that the local server 38, 200 resides in the application layer of the receiver's software stack, it can be implemented in lower layers. Having it in the application layer offers particular technical advantages in terms of the ability to install and/or upgrade over the air.

Technical advantages offered by the above embodiments include:
The ability to install, upgrade and modify any receiver device supporting a known standard without having to modify the architecture or firmware of the device;
The ability to support one or more proprietary A-GPS/A-GNSS services or sources, including services for long-term ephemeris data, services for positioning (Cell-ID, enhanced Cell-ID, Wifi and so on), services for reference time (such as NTP) and services for A-GPS/A-GNSS accuracy enhancements such as differential GPS/GNSS.
Version control is straightforward if the local server 38, 200 is installed and executed in the application layer.
Flexible modularity in terms of architecture, because the local server 38, 200 can be at a different layer from the protocol and receiver modules.
Use of proprietary format and protocols for IEs permits performance improvements in terms of sensitivity and TTFF over the standardized approaches and other possible effects such as power savings due to shorter TTFFs and minimized use of data connectivity e.g. when roaming. For example, a long-term ephemeris service allows assistance data generation within the device, so there is no need to establish a data connection to an external server as the request can be served locally.
Upgrading legacy receivers is possible by means of a high-level software upgrade i.e. update to the local server 38, 200 only. No changes to the low-level hardware or firmware is needed which is usually very difficult to carry out.

Regarding security, the interface between the external server (s) 32, 108 and the local SUPL server 38, 200 and the local SUPL server and the protocol module 34 (and indeed any other communications interface internally) can use different security levels, protocols or methods. For example, the connection between the local SUPL server 38, 200 and the external server (s) 32, 108 can use secure shell (SSH) type security whereas a transport layer security (TLS) secure connection can be used by the local SUPL server 38, 200 to connect to the protocol module 34 and any other internal interface. Alternatively, the use of operating system—level hidden/restricted APIs can be used as the alternative security means internally. One advantage of this is that the proprietary protocol could offer better security than SUPL, and also authentication. This could reduce the risk that the device receives false or spoofed assistance data from the servers.

In summary, it is possible to implement existing and new proprietary assistance data services with existing and new receiver devices, by providing a local server module in the device configured to convert (in terms of IE format and/or communications protocol) between a proprietary method or service and a standardised one, aspects of which will be different. The existing receiver and its associated protocol module require minimal change, save for changing the address (or URL) to which the protocol module connects when assistance data is required.

It will be appreciated that the above described embodiments are purely illustrative and are not limiting on the scope of the invention. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-49. (canceled)

50. An apparatus comprising:
a local data server configured to connect to an external source of position assistance data, to receive said data in a first predetermined format and to convert it into a second predetermined format for provision within the apparatus;
a satellite positioning receiver; and
a receiver protocol module associated with said receiver and configured, in response to a request to provide position assistance data to said receiver, to request said position assistance data from the local data server, to receive it in the second predetermined format and to convert it into a third predetermined format suitable for said receiver.

51. The apparatus according to claim 50, wherein the local data server is configured to connect to a plurality of different external sources of position assistance data and to receive respective different sets of position assistance data for conversion into the second predetermined format.

52. The apparatus according to claim 51, wherein the local data server is configured to combine data from the different sets of position assistance data to provide a new set of position assistance data for conversion into the second predetermined format.

53. The apparatus according to claim 50, wherein the local data server is configured to connect to the external source of position assistance data using a packet-switched connection.

54. The apparatus according to claim 50, wherein the local data server is configured to connect to the external source of position assistance data over a cellular communications network.

55. The apparatus according to claim 50, wherein the local data server is configured to connect to the external source of position assistance data to obtain the position assistance data in response to a request received from the receiver protocol module.

56. The apparatus according to claim 50, wherein the local data server is configured automatically and periodically to connect to the external source of position assistance data to obtain the position assistance data for storage and provision to the receiver protocol module at a later point in time.

57. The apparatus according to claim 50, wherein the local data server is provided as an application-level program.

58. The apparatus according to claim 57, wherein the local data server is configured so as to be reconfigurable or replaceable from an external location over a communications network.

59. The apparatus according to claim 50, wherein the local data server has an associated local port address to which the receiver protocol module is configured to connect to in order to request position assistance data.

60. The apparatus according to claim 59, wherein the local port address is a local IP address.

61. The apparatus according to claim 50, wherein the local data server is configured to receive the position assistance data in the form of one or more information elements in a non-binary encoded format and to convert the one or more information elements into a binary encoded format.

62. The apparatus according to claim 50, wherein the local data server is configured to receive position assistance data in the form of one or more information elements conforming to a first schema and to convert the one or more information elements into a second schema.

63. A method comprising:
(i) connecting to an external source of position assistance data, receiving said data in a first predetermined format, and converting it into a second predetermined format; and
(ii) responsive to a request for position assistance data, requesting and receiving position assistance data from a local data server in the second predetermined format, converting the position assistance data into a third predetermined format suitable for a satellite positioning receiver, and providing the converted position assistance data to the satellite positioning receiver.

64. The method according to claim 63, wherein (i) further comprises connecting to a plurality of different external sources of position assistance data and receiving respective different sets of position assistance data for conversion into the second predetermined format.

65. The method according to claim 64, wherein (i) further comprises combining data from the different sets of position assistance data to provide a new set of position assistance data for conversion into the second predetermined format.

66. The method according to claim 63, wherein (i) is performed using at least one of a TCP/IP connection and a cellular communications network.

67. The method according to claim 63, wherein (i) is performed automatically and periodically to obtain the position assistance data for use in (ii) at a later point in time.

68. The method according to claim 63, wherein (i) is performed by the local data server provided as an application-level program.

69. A non-transitory computer-readable storage medium having stored thereon computer-readable code, which, when executed by a computing apparatus, causes the computing apparatus to perform a method comprising:
(i) connecting to an external source of position assistance data, receiving said data in a first predetermined format, and converting it into a second predetermined format; and
(ii) responsive to a request for position assistance data, requesting and receiving position assistance data from a local data server in the second predetermined format, converting the position assistance data into a third predetermined format suitable for a satellite positioning receiver, and providing the converted position assistance data to the satellite positioning receiver.
